(19) United States
(12) Patent Application Publication
(10) Pub. No.: US 2012/0174173 A1
(43) Pub. Date: Jul. 5, 2012

(54) STATISTICS RETRIEVAL AND DISPLAY SYSTEM

(76) Inventor: Garrett Brood, Mount Laurel, NJ (US)

(21) Appl. No.: 13/330,755

(22) Filed: Dec. 20, 2011

Related U.S. Application Data
(60) Provisional application No. 61/429,122, filed on Jan. 1, 2011.

(51) Int. Cl. H04N 21/60

(52) U.S. Cl. 725/110

(57) ABSTRACT

An interactive Web-feed/television broadcast dual display system that enables a user to access any information currently available on the Internet without disrupting a television broadcast he/she may be currently watching. Web-based content is selected at the will of the viewer and is displayed on a desired area of his/her display screen without changing the television channel. That is, the Internet data a user chooses to display is unique and autonomous from the content being displayed via their broadcast television source. In this way, a user has the freedom to search the Internet, preferably in a desired area of the television screen, without affecting the current television broadcast or input source.

### CROSS REFERENCE TO RELATED APPLICATION

This application claims the benefit of U.S. Provisional Application No. 61/429,122, filed Jan. 1, 2011.

### FIELD OF THE INVENTION

The present invention relates in general to information retrieval systems and in particular to systems for selectively accessing a Web-based data feed and concurrently displaying such data feed concurrently with a broadcast television broadcast feed.

### BACKGROUND OF THE INVENTION

Currently, one can retrieve information via computer, iPhone®, smart phone, cell phone, iPad®, and various other types of interactive electronic devices. For instance, one can search for readily available and continuously updated statistics at many websites. Examples in the sports context include ESPN.com, sports.yahoo.com, baseball-reference.com, NFL.com, MLB.com, NHL.com, NBA.com, and the like.

As used herein the terms “stats”, “statistics”, “statistical” or words of similar effect shall be construed to mean any readily quantifiable information including, but not limited to sports, wagering, political, demographic, weather, financial and other data. In the sports context, for example, such stats might include a baseball player's current year or career batting average, a golfer's career par on a specific course, a swimmer's top ten Olympic times, a football quarterback's current year or career interceptions, a hockey player's current year or career goals or a basketball player's current year or career rebounds, assists or blocked shots. In the political context, for example, such stats might include a politician's career election victories and losses, voter demographics, etc. Other useful and desirable statistical data will be readily appreciated by the reader.

Additionally, using the sports context as an example, one may view a televised sports channel such as ESPN® or watch a live event and wait for desired statistical information to be displayed—which information may never be announced or displayed. In the alternative, one may employ a TIVO®, On-Demand box or other television-compatible time-shifting device to track a very limited amount of sports statistics. However, these devices cannot provide information in real time and none have the capability of being completely customizable and interactive.

Further, technology presently exists for simultaneously displaying a television broadcast with Internet or other Web-accessible data. However, the displayed information is keyed to the specific content (e.g., a movie, a news broadcast, a drama, a comedy, a sporting event, etc.) being broadcast on the selected television channel. However, one cannot access and view on his/her television set data or information, e.g., statistical information, unrelated to the program being broadcast.

An advantage exists, therefore, for a system for enabling a television viewer to selectively retrieve and view in real time Web-based information unrelated to a television broadcast the user is presently viewing.

### SUMMARY OF THE INVENTION

The present invention provides an interactive Web-feed/television broadcast dual display system that enables a user to access any information currently available on the Internet (or other network or database) without disrupting a television broadcast he/she may be currently watching. In contrast, existing systems require both a television broadcast and Web-based data specifically keyed to the television broadcast to be incorporated into one television display screen. That is, technology already exists whereby a user may obtain information about the television broadcast they are currently viewing, so long as it is related to the broadcast. For example, existing interactive Web-television devices permit a user to access content regarding a sporting event they are currently watching but would not permit the user to search for information unrelated to the sporting event.

Significantly, in the instant system all Web-based content is selected at the will of the viewer and is displayed on a desired area of his/her display screen without changing the television channel. In other words, the Internet data a user chooses to display is unique and autonomous from the content being displayed via their broadcast television source. In this way, a user has the freedom to search the Internet, preferably in a desired area of the display screen, without ever affecting the current broadcast or input source.

Various examples and embodiments of the present system described herein with reference to specific television programs, broadcast sources, display information, Internet data and the like are merely representative examples of various applications of the present system but are not intended to be nor should they be construed to be limited thereto.

In any case, a user would have access to customized networks and data streams which would communicate with the device to display content directly on the user's display device, e.g., television set, simultaneously with the television broadcast stream. In this way, the user would not only be able to freely search the Internet for whatever content he/she seeks, but would also be able to access organized accumulations of information via a server or external network.

For example, a user watching a news program or a movie could simultaneously search the Internet for content unrelated to the content of the news broadcast or movie. The broadcast would remain, as intended by the broadcast provider, but the present system would permit the viewer to concurrently search the Internet for unrelated content. Likewise, someone watching a football game could not only search for more information pertinent to the football game, but also search for and simultaneously display unrelated information, for example, stock information, restaurant information, weather information, etc.

Unlike current Web-television devices, the present system does not interlace and combine both the Internet data and the television broadcast streams into a single display stream. Instead, it separates the two streams, thereby allowing the user to manipulate and interact with the device display and Internet data without changing or manipulating in any way the actual and original television broadcast. Preferably, the television broadcast is slightly compressed when the Web-based data feed is accessed in order to minimize detrimental impact on the broadcast display quality while allowing for an area of the television screen to be used as a display window for the Web-based data feed. Within the area of the television display screen dedicated for Web-based data (which, depending on how the user initially set up the information to be displayed, may be above, beneath or to either side of the broadcast image), a user may then access Internet content by remote control.

According to a presently preferred embodiment, the system includes a device that may be connected to the Internet either wirelessly, by Ethernet, coaxial cable connection, or by any other suitable presently known or hereinafter developed means. Additionally, the device may be connected to a television set via audio/video cables, coaxial cables, HDMI, satellite, wirelessly or by any other suitable presently known or hereinafter developed means.

It is contemplated that the device may be AC or DC powered (or AC with a DC back-up in the event of a power failure) and is preferably operated by remote control. When the device is first activated, a main menu would appear on the television screen and, using the remote, a user would select what information he/she desires to be displayed, as well as where he/she wants it to be displayed on the screen.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is a schematic view of an interactive Web-feed/television broadcast dual display system according to the invention;

FIG. 2 is a schematic flow diagram of the operation of an interactive Web-feed/television broadcast dual display system according to the invention;

FIG. 3 is a schematic view of a remote control suitable for use in the system according to the invention;

FIGS. 4A-4E are views of representative statistical data that may be displayed on a display screen during operation of the present system;

FIG. 5 is a view of a display screen depicting an interactive Web-feed/television broadcast dual display according to the invention; and

FIG. 6 is another view of a display screen depicting an interactive Web-feed/television broadcast dual display system according to the invention.

### DETAILED DESCRIPTION OF THE INVENTION

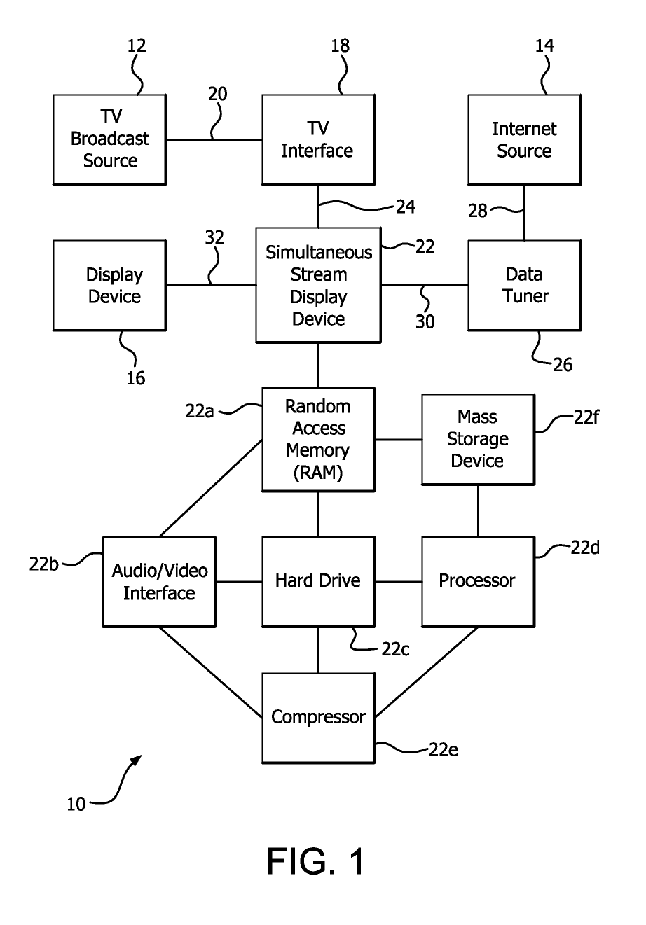

Referring to the drawings wherein like or similar references indicate like or similar elements throughout the several views, there is shown in FIG. 1 an interactive Web-feed/television broadcast dual display system according to the invention as it would be implemented in an arrangement comprising a television (TV) broadcast source 12, an Internet source 14 and a display device 16 having a display screen. Display device may be, but is not limited to a television, a tablet computer, a smart phone, or the like, the screen of which visually displays the data feeds transmitted by TV broadcast source 12 and Internet source 14.

TV broadcast source 12 communicates with TV interface 18 via communications link 20. Broadcast source 12 may be any source of broadcast content provided by a user's broadcast source provider such as, for example, entertainment, sports, financial or news information. Communications link 20 may include but is not limited to audio/video cables, coaxial cables, fiber optic cables, WIFI, HDMI, s-video, satellite, wireless or any other suitable presently known or hereinafter developed means. TV interface 18 may be, but is not limited to, any device (e.g., a cable box or satellite dish) provided by the user's broadcast source provider, operable to convert the content transmitted by TV broadcast source 12 to a format compatible with display device 16 and/or simultaneous stream display device 22, discussed in greater detail below.

TV interface 18 is connected to a simultaneous stream display device (also referred to herein as a “streaming device”) 22 via a communications link 24 which may be, but is not limited to, audio/video cables, coaxial cables, fiber optic cables, WIFI, HDMI, s-video, satellite, wireless or any other suitable presently known or hereinafter developed means.

Internet source 14, which may be any suitable presently or hereinafter available Internet provider, is connected to a data tuner 26 via a communications link 28 which may be, but is not limited to, coaxial cables, fiber optic cables, WIFI, satellite, wireless or any other suitable presently known or hereinafter developed means. Data tuner 26 decodes Internet source data and connects the data feed from Internet source 14 to simultaneous stream display device 22 via a communications link 30 which may be, but is not limited to, coaxial cables, fiber optic cables, WIFI, HDMI, satellite, wireless or any other suitable presently known or hereinafter developed means. A communications link 32, which may be, but is not limited to, coaxial cables, fiber optic cables, WIFI, HDMI, satellite, wireless or any other suitable presently known or hereinafter developed means, connects simultaneous stream display device 22 to display device 16.

Simultaneous stream display device 22 preferably includes most, if not all, of components 22a-22f shown in FIG. 1. At minimum, device 22 includes a random access memory (RAM) 22a for providing accessible storage for previously searched and user-specific information. User-specific information includes manually programmed input and other information pertaining to content of interest to the user such as bibliographic/identity information and information corresponding to previously searched information and even stored “favorites” information.

Component 22b is an audio/video (A/V) interface that communicates A/V signals to display device 16 via stream device 22 and communications link 32. Component 22c is the hard drive component of stream device 22 and, in conjunction with processor 22d, provides device 22 with the functional capabilities enumerated and described herein.

Component 22e is an optional, but preferable, compressor for compressing the information broadcast by TV broadcast source 12 to provide space on the display device's screen sufficient to accommodate the data transmitted by Internet source 14, yet still retain the essential fidelity of the video image projected by the display device display screen. Component 22f is an optional mass storage device which desirably stores large audiovisual files much in the same way as a TIVOC) or other time-shifting device.

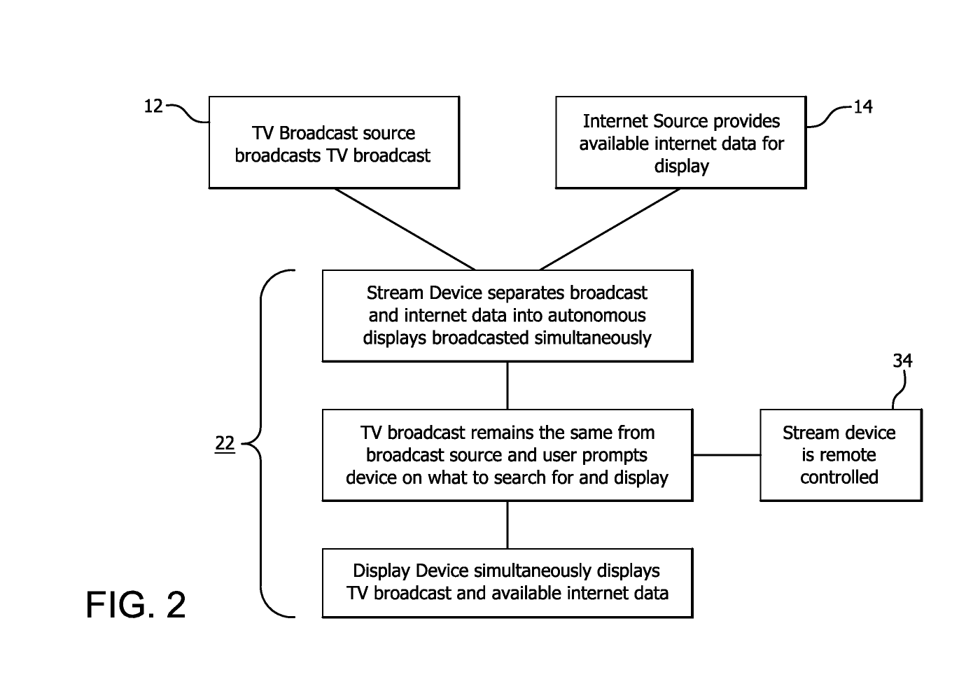

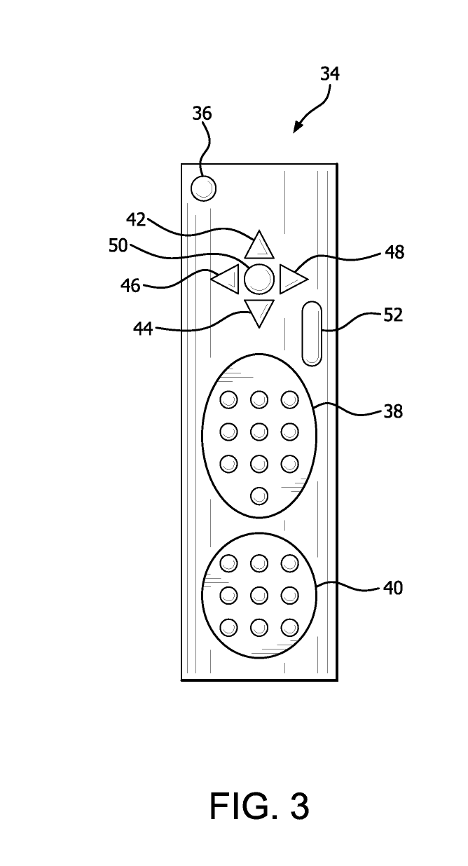

FIG. 2 enlarges upon the method by which the present system performs the essential functions of the invention. More particularly, the feeds from TV broadcast source 12 and Internet source 14 are simultaneously delivered to simultaneous stream display device 22 in the manner described above in connection with FIG. 1. Unlike other Web-TV devices, however, device 22 separates and maintains separation of the television and Internet data feeds. That is, the television broadcast source remains fully intact as an independent and unaffected stream with no manipulability capability other than the selective changing of its “channel” by a user via remote control 34 (described below in connection with FIG. 3).

In contrast, device 22 permits selective manipulation of the Internet stream and thus the corresponding data feed the user observes on the display device 16 (FIG. 1). Indeed, device 22 desirably compresses and displays a reduced size but otherwise unchanged television broadcast while at the same time also displaying an area of Internet data that is user-manipulable or customizable via prompts entered into remote control 34.

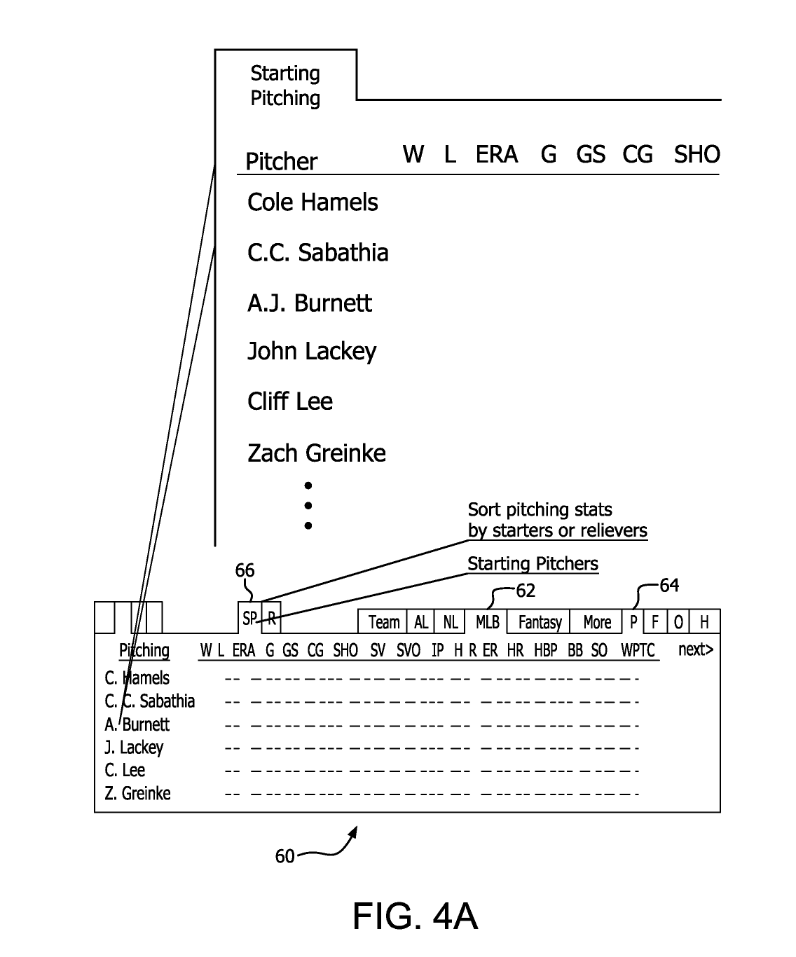

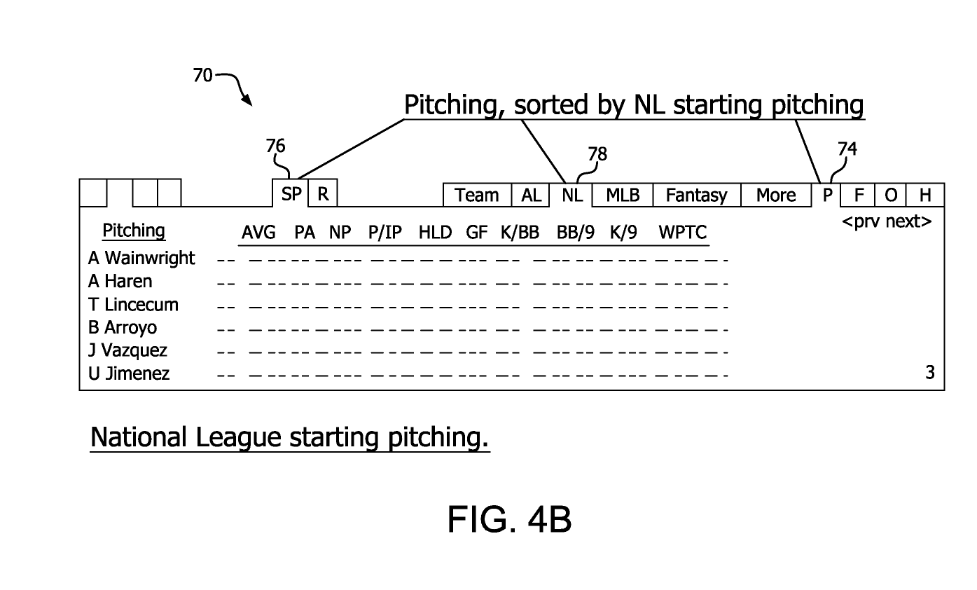

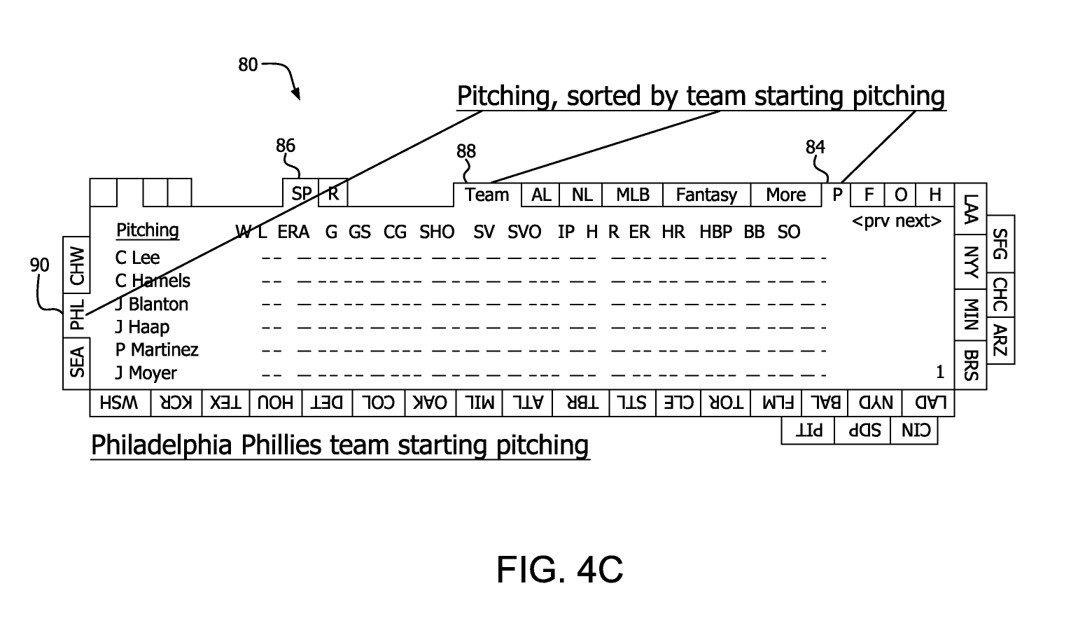

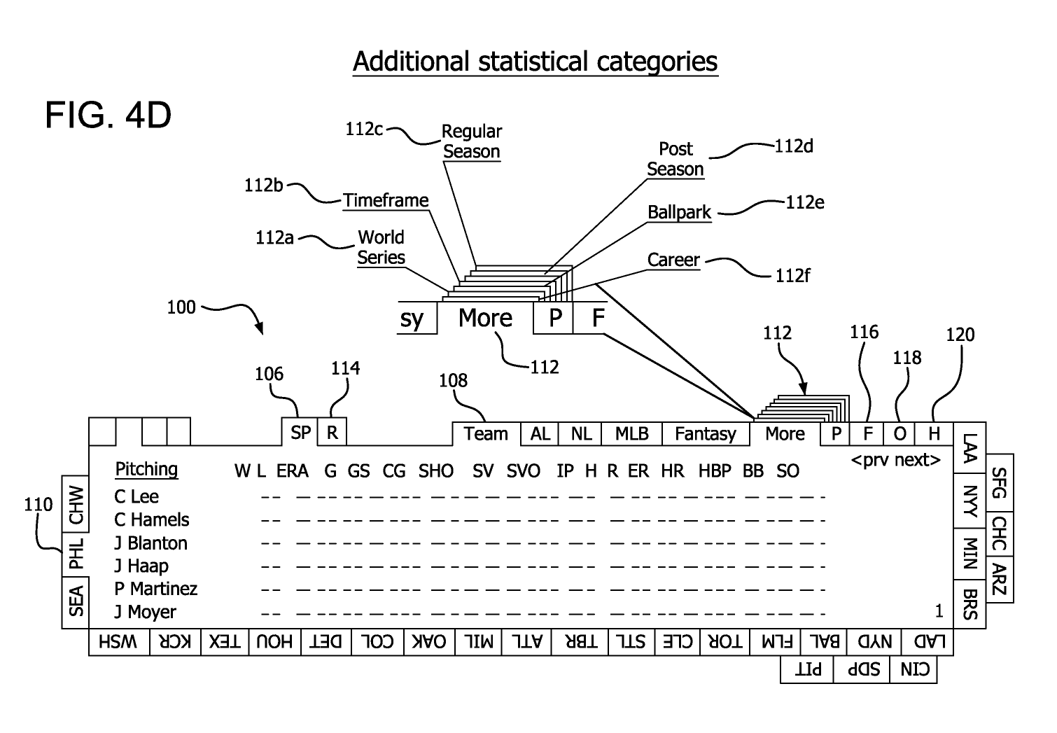

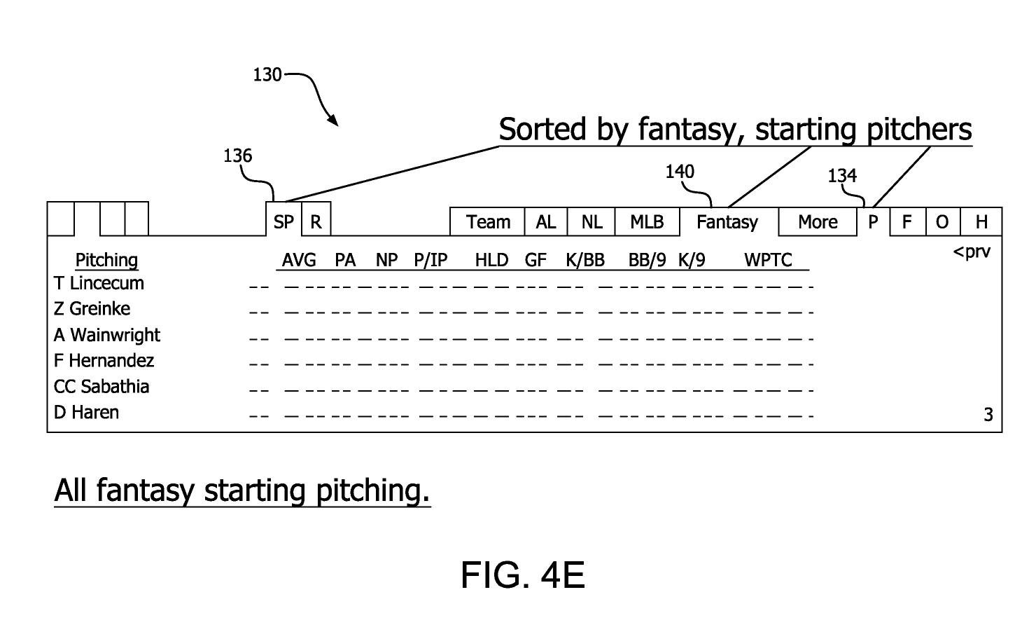

Referring to FIG. 3, there is shown a remote control 34 suitable for use in the interactive Web-feed/television broadcast dual display system according to the invention. As is known, remote control may transmit any suitable form of radiation, such as infrared radiation, capable of controlling operation of device 22 and includes a power or “on-off” button 36 for activating and deactivating device 22. In addition, remote 34 includes numeric buttons 38 depicted as an array of 10 buttons corresponding to the numerals 0-9, which buttons could be supplemented or replaced by “up” and “down” arrow buttons (not illustrated) in the manner known in the art. Depending on the mode in which remote 34 is operating, numeric buttons 38 may be used in a first mode to select desired channels for the incoming television broadcast or in a second mode to input numeric data into the streaming device 22 for retrieving statistical data wherein numerical data by itself or in combination with alphabetical characters may be needed in order to retrieve desired statistical data from the incoming Internet stream. Remote 34 further includes a keyboard 40 capable of supporting at least all of alphabetical characters “A” through “Z” in order to permit a user to enter specific queries into streaming device 22 relating to any information retrieval query of interest. Remote further preferably includes “Up” 42, “Down” 44, “Left” 46 and “Right” 48 arrows for enabling navigation through statistical information windows such as those shown in FIGS. 4A-4E discussed below. Remote control 34 further preferably includes an “Enter” button 50 for confirming the commands input by, for example, numeric buttons 38, keyboard 40 and the “Up”, “Down”, “Left” and “Right” arrows 42-48. And, remote 34 also desirably includes a “Mode” button 52 for permitting the user to switch between the channel changing and data input modes discussed above.

FIGS. 4A-4E illustrate how the present invention may be used to access and manipulate desired data from an Internet stream delivered by streaming device 22 using remote control 34. It will be understood that the various “tabs” referred to in FIGS. 4A-4E may be accessed and selected by proper manipulation of the “Up”, “Down”, “Left” and “Right” arrows 42-48 and the “Enter” button 50 described above in connection with remote control 34. Further, although the selected data is described and illustrated as being associated with sports information in FIGS. 4A-4E, specifically Major League Baseball, it will be understood that the present system is capable of retrieving and manipulating any sort of statistics that may be of interest to a particular user.

Before accessing the windows shown in FIGS. 4A-4E, a user interested in retrieving and viewing statistics pertaining to professional baseball first deploys “Mode” button 52 into the data input mode and, using keyboard 40, enters the search request “professional baseball” and presses the Enter button 50. At which point, a window on the display device screen appears which prompts the user to select between “Major League” and “Minor League” (if Minor League” is selected, the user will then be prompted to select the “class” of minor league baseball statistics in which the user may be interested, e.g., AAA, AA or A). Assuming the user is interested in viewing major league statistics, the user selects “Major League”. And, if the user is interested specifically in the statistics of all presently active Major League Baseball (MLB) starting pitchers, the user selects “pitchers” and “starting pitchers” tabs (discussed below) at which point the window shown in FIG. 4A appears.

Referring to FIG. 4A, there is shown a window 60 listing all presently active Major League Baseball (MLB) pitchers (P), specifically starting pitchers (SP), which MLB, P and SP tabs are identified by reference numerals 62, 64 and 66, respectively. Projected above window 60 is a view of the left region of window 60 showing, on an enlarged scale, the pitchers' names and some of their associated pitching statistics, e.g., wins (W), losses (L), games played (G), games started (GS), complete games (CG), shutouts (SHO), etc., which statistics, as will be discussed below, may cover any time frame the user desires.

Turning to FIG. 4B, there is shown a window 70 listing all presently active pitchers (P), specifically starting pitchers (SP) in the National League (NL), which P, SP and NL tabs are identified by reference numerals 74, 76 and 78, respectively.

In FIG. 4C, there is shown a window 80 listing all presently active pitchers (P) , specifically starting pitchers (SP), by team (TEAM) on a specific team roster, namely, the Philadelphia Phillies (PHI), which P, SP, Team and PHI tabs are identified by reference numerals 84, 86, 88 and 90, respectively.

In FIG. 4D, there is shown a window 100 listing all presently active starting pitchers (SP), by team (TEAM) on a specific team roster, namely, the Philadelphia Phillies (PHI), which SP, Team and PHI tabs are identified by reference numerals 106, 108 and 110, respectively. Also illustrated in FIG. 4D is an additional “More” tab (More) 112 which, when accessed, provides the user with additional statistical information regarding a selected starting pitcher on the Philadelphia Phillies active starting pitching roster, e.g., Cliff Lee.

In this regard, projected above window 100 is an enlarged view of the More tab 112 which may provide the user with access to additional statistical information concerning the selected starting pitcher including, without limitation, World Series record 112a, record within a particular timeframe 112b, regular season record 112c, post-season record 112d, record in a specific ballpark 112e and career record 112f. It will be appreciated that the examples of “More” statistical information depicted in FIG. 4D represent a small sample of the many types of statistical data that might be accessed via the present system for a particular starting pitcher playing on any MLB team. It will likewise be understood that the foregoing information access processes described in connection with FIGS. 4A-4D may easily reproduced for relief pitchers by clicking on the relief tab (R) 114 shown in FIG. 4D (or its counterpart in any of FIGS. 4A-4C). Likewise, the examples shown in FIGS. 4A-4D are not limited to retrieval of pitching statistics. For instance, each of the above-described windows preferably includes additional tabs for fielding (F), offense (0) and hitting (H), which are identified in FIG. 4D by reference numerals 116, 118 and 120, respectively. Indeed, clicking on these tabs will call up appropriate statistics for each active MLB player, National/American league player, or team player that the user may choose to select.

In FIG. 4E, there is shown a window 80 listing all presently active pitchers (P) , specifically starting pitchers (SP), selected for a user's fantasy baseball team (Fantasy), which P, SP and Fantasy tabs are identified by reference numerals 134, 136 and 140, respectively. Again, FIG. 4E may be manipulated to provide the user with any information of interest including but not limited to starting and relief pitching stats, hitting stats, fielding stats, and so on.

In addition to the foregoing examples, the interactive capability of the present system is such that the user can scroll over any individual's name and choose to open up that person's individual stats page and organize it in any way they choose using remote control 34.

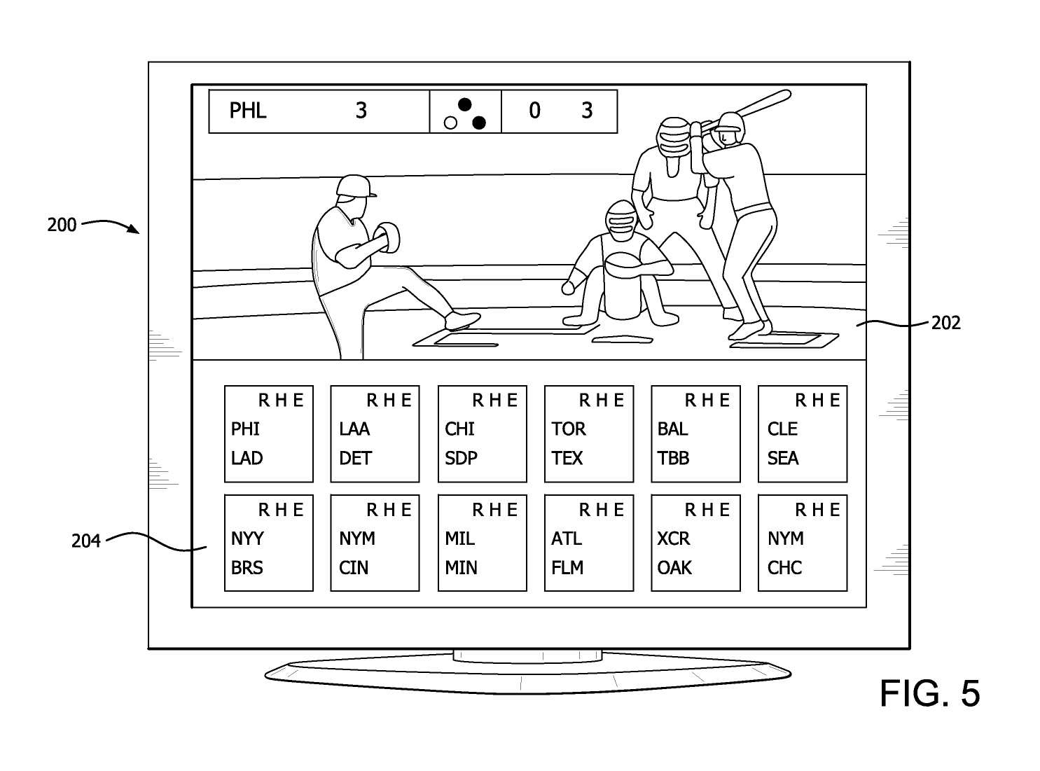

FIG. 5 is a view of a television screen 200 depicting an interactive Web-feed/television broadcast dual display according to the invention. As seen in FIG. 5, the dual screen image reveals the user's current television broadcast image 202 (in this instance, a baseball game) along with sports statistics (in this instance, coincidentally, abbreviated baseball box scores generated by selection of an unillustrated “live scoreboard” tab similar to the tabs described above in connection with FIGS. 4A-4E) in a window 204 situated beneath TV broadcast image 202. It will be understood that the user may select where the stats window may be situated on screen 202 (e.g., above, below or to the left or right of the broadcast image). Further, the “live scoreboard” tab desirably enables the scores of single as well as multiple sporting events to be displayed simultaneously in window 204 while permitting the user to gain more detailed information regarding particular contest(s) of interest. Significantly, despite the Internet feed shown in window 204 containing baseball-related statistical data and such data coincidentally being displayed with a baseball game broadcast in FIG. 5, it is a central feature and advantage of the present invention that the Internet feed be entirely independent of the television broadcast content.

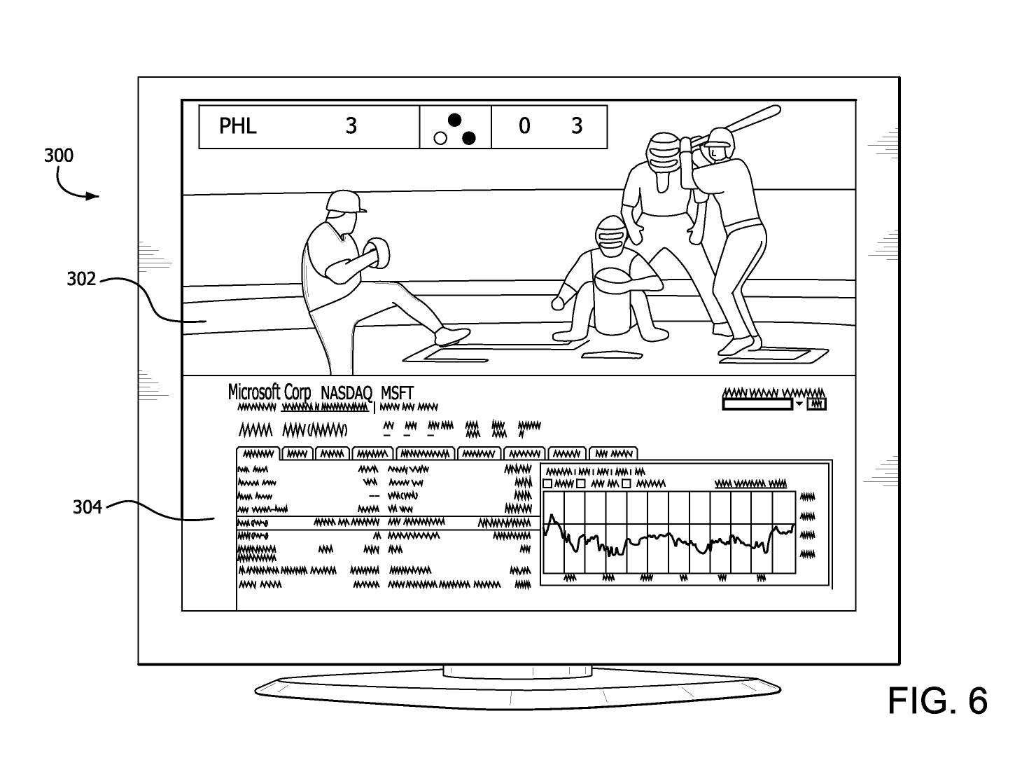

Turning to FIG. 6 there is provided another view of a television screen, identified by reference numeral 300, depicting an interactive Web-feed/television broadcast dual display according to the invention. As seen in FIG. 6, the dual screen image reveals the user's current television broadcast image 302 (in this instance, a baseball game) along with financial statistics (in this instance, stock information) in a window 304 situated beneath broadcast image 302.

Regardless of the information displayed in the Internet feed window, the information and stats would be updated and/or refreshed continuously. A person would be able to view any stat from any game, from any team, in any sport. Moreover, while the game is still playing, while on commercial break or on a different channel altogether, a person would be able to turn on the device and view stats from any sporting or athletic game.

As the reader will appreciate, the instant system possesses the capability to display statistical information for any sporting or athletic event including but not limited to: auto racing, basketball, baseball, football, hockey, cricket, volleyball, golf, softball, skateboarding, surfing, skydiving, mountain biking, track and field, bowling, cycling, X Games®, BMX racing, dirt biking, unicycle trials, UFC®, kung fu, ju-jitsu, wrestling, paint ball, fencing, karate, mixed martial arts, pool, swimming, fishing, flying disc sports, gymnastics, hunting, motorboat racing, motorcycle racing, Olympic sports, canoeing, kayaking, rafting, rowing, polo, water polo, running, skiing, snowboarding, bobsled, luge, skeleton, weightlifting, strongest man competitions, competitive board games, etc., as well as collegiate, high school, grade school, and pee-wee versions of the foregoing, and every other sporting or athletic event at every competitive level.

Preferably, the streaming device according to the invention is capable of storing frequently conducted or “favorites” data searches. Additionally, in the sports context, the device would also be able to display biographies and other information about a player, such as, but not limited to, a player's height, weight, college attended, batting stance, throwing hand, etc.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. Apparatus for displaying a television broadcast feed and an Internet data feed on a display device, the apparatus comprising:
means for receiving a television broadcast feed;
means for receiving an Internet data feed, said Internet data feed containing data independent of said television broadcast feed; and
means for simultaneously transmitting to the display device said television broadcast feed and said Internet data feed as separate streams.

2. The apparatus of claim 1 wherein said television broadcast feed is substantially unaltered by said apparatus.

3. The apparatus of claim 1 further comprising means for compressing said television broadcast feed to accommodate said Internet data feed on the display device.

4. The apparatus of claim 1 wherein the display device is a television screen.

5. The apparatus of claim 1 further comprising means for manipulating said Internet data feed.

6. The apparatus of claim 5 wherein said manipulating means comprise a remote control.

7. The apparatus of claim 1 wherein said Internet data feed comprises statistical information.

8. The apparatus of claim 7 further comprising means for manipulating said statistical information.

9. The apparatus of claim 8 wherein said manipulating means comprises a remote control.

10. A method for displaying a television broadcast feed and an Internet data feed on a display device, the apparatus comprising:
receiving a television broadcast feed;
receiving an Internet data feed, said Internet data feed containing data independent of said television broadcast feed; and
simultaneously transmitting to the display device said television broadcast feed and said Internet data feed as separate streams.

11. The method of claim 10 wherein said television broadcast feed is substantially unaltered by said apparatus.

12. The method of claim 10 further comprising compressing said television broadcast feed to accommodate said Internet data feed on the display device.

13. The method of claim 10 wherein the display device is a television screen.

14. The method of claim 10 further comprising manipulating said Internet data feed.

15. The method of claim 14 wherein said manipulating is performed by remote control.

16. The method of claim 10 wherein said Internet data feed comprises statistical information.

17. The method of claim 16 further comprising manipulating said statistical information.

18. The method of claim 17 wherein said manipulating is performed by remote control.
